(19) United States
(12) Patent Application Publication
(10) Pub. No.: US 2018/0058516 A1
(43) Pub. Date: Mar. 1, 2018

(54) CLUTCH

(71) Applicant: DENSO CORPORATION, Kariya-city, Aichi-pref. (JP)

(72) Inventors: Yousuke YAMAGAMI, Kariya-city (JP); Hirotaka MATSUMOTO, Kariya-city (JP); Motohiko UEDA, Kariya-city (JP); Masashi TOBAYAMA, Kariya-city (JP); Satoshi KAWAKAMI, Kariya-city (JP)

(21) Appl. No.: 15/557,491

(22) PCT Filed: May 23, 2016
(86) PCT No.: PCT/JP2016/065149

§ 371 Date: Sep. 12, 2017

(30) Foreign Application Priority Data
May 28, 2015 (JP) 2015-108827

(51) Int. Cl. F16D 27/112; F16D 13/64; C23C 8/30

(52) U.S. Cl. CPC F16D 27/112; F16D 13/64; F16D 13/40; F16D 2200/0021; C23C 8/30

(57) ABSTRACT

A clutch includes: a rotor that has a steel material as a base material and is rotated upon receiving a rotational drive force from a drive source; and an armature that has a steel material as a base material and receives the rotational drive force from the rotor when the armature is attracted to the rotor by a magnetic force. The armature has a contact surface side region that includes a contact surface, which contacts a counterpart when the armature is attracted to the rotor. The contact surface side region has a plurality of pores opened at the contact surface and forms a nitride compound of an element of the base material through nitridization of a part of the base material while the contact surface side region is harder than an unreacted portion of the base material that is not reacted at the nitridization.

### CROSS REFERENCE TO RELATED APPLICATION

This application is based on and incorporates herein by reference Japanese Patent Application No. 2015-108827 filed on May 28, 2015.

### TECHNICAL FIELD

The present disclosure relates to a clutch.

### BACKGROUND ART

In a dry electromagnetic clutch, a friction surface of an armature and a friction surface of a rotor in an initial state immediately after formation of the friction surfaces through a cutting process and a polishing process have a relatively small friction coefficient, so that a transmission torque is small. However, it is known that when transmission and block of the torque are repeated, the friction coefficient is increased due to oxidation of both of the friction surfaces, so that the transmission torque is increased (see, for example, the patent literature 1).

In view of the above point, previously, a run-in operation is executed before shipment of a product (i.e., the clutch) from a factory. In the run-in operation, the transmission and the block of the torque are actually repeated to oxidize the friction surfaces, so that the transmission torque of the electromagnetic clutch is increased. Alternatively, the run-in operation is not performed before the shipment of the product from the factory, and the effect of the run-in operation is obtained through the use of the product on the market after the shipment of the product.

### CITATION LIST

### Patent Literature

### PATENT LITERATURE 1: JP2003-314585A

### SUMMARY OF INVENTION

However, in the previously proposed clutch, it takes a long time before occurrence of that the transmission torque is increased in comparison to the initial state of the friction surfaces, and the high transmission torque is stably obtained.

Therefore, in the case where the run-in operation is performed before the shipment of the product from the factory, the time of run-in operation at the manufacturing process of the clutch is disadvantageously increased, and thereby the time, which is required for the manufacturing of the clutch, is disadvantageously increased. Also, in the case where the product is shipped without performing the run-in operation, the time, which is required for increasing the transmission torque from the time of starting the use of the product to the time of stably obtaining the high transmission torque after increasing of the transmission torque, is disadvantageously increased. This may possibly become a factor for malfunctioning of the clutch.

It is an objective of the present disclosure to provide a clutch that can increase a transmission torque within a short period of time and thereby achieve a stable high transmission torque.

According to one aspect of the present disclosure, a clutch includes:

a rotor that has a steel material as a base material of the rotor, wherein the rotor is rotated when the rotor receives a rotational drive force from a drive source; and

an armature that has a steel material as a base material of the armature, wherein the rotational drive force is conducted to the armature when the armature is attracted to and is engaged with the rotor by a magnetic force, wherein:

the armature includes a contact surface side region that includes a contact surface, which contacts a counterpart when the armature is attracted to and is engaged with the rotor; and

the contact surface side region includes a plurality of pores that open at the contact surface, wherein a nitride compound of an element of the base material of the armature is formed at the contact surface side region through nitridization of a portion of the base material of the armature while the contact surface side region is harder than an unreacted portion of the base material of the armature, which is unreacted at the nitridization.

According to another aspect of the present disclosure, a clutch includes:

a rotor that has a steel material as a base material of the rotor, wherein the rotor is rotated when the rotor receives a rotational drive force from a drive source; and

an armature that has a steel material as a base material of the armature, wherein the rotational drive force is conducted to the armature when the armature is attracted to and is engaged with the rotor by a magnetic force, wherein:

the armature includes a contact surface side region that includes a contact surface, which contacts a counterpart when the armature is attracted to and is engaged with the rotor; and

the contact surface side region includes a plurality of pores that open at the contact surface, wherein a nitride compound of an element of the base material of the armature is formed at the contact surface side region while the contact surface side region is harder than the base material of the armature.

According to a further aspect of the present disclosure, a clutch includes:

a rotor that has a steel material as a base material of the rotor, wherein the rotor is rotated when the rotor receives a rotational drive force from a drive source; and

an armature that has a steel material as a base material of the armature, wherein the rotational drive force is conducted to the armature when the armature is attracted to and is engaged with the rotor by a magnetic force, wherein:

the rotor includes a contact surface side region that includes a contact surface, which contacts a counterpart when the armature is attracted to and is engaged with the rotor; and

the contact surface side region includes a plurality of pores that open at the contact surface, wherein a nitride compound of an element of the base material of the rotor is formed at the contact surface side region through nitridization of a portion of the base material of the rotor while the contact surface side region is harder than an unreacted portion of the base material of the rotor, which is unreacted at the nitridization.

According to a further aspect of the present disclosure, a clutch includes:

a rotor that has a steel material as a base material of the rotor, wherein the rotor is rotated when the rotor receives a rotational drive force from a drive source; and

an armature that has a steel material as a base material of the armature, wherein the rotational drive force is conducted to the armature when the armature is attracted to and is engaged with the rotor by a magnetic force, wherein:

the rotor includes a contact surface side region that includes a contact surface, which contacts a counterpart when the armature is attracted to and is engaged with the rotor; and

the contact surface side region includes a plurality of pores that open at the contact surface, wherein a nitride compound of an element of the base material of the rotor is formed at the contact surface side region while the contact surface side region is harder than the base material of the rotor.

In the clutch of the present disclosure, by repeating coupling and decoupling (i.e., transmission and block of a torque) between the armature and the rotor, abrasion of the contact surface side region occurs, and thereby hard abrasion powder is generated. The thus generated abrasion powder is received and held in the pores of the contact surface side region. Therefore, at the time of attracting and engaging the armature to the rotor (i.e., at the time of transmitting the torque), a real contact area between the armature and the rotor is improved. Also, due to the presence of the hard abrasion powder between the contact surface of the armature and the contact surface of the rotor, a friction resistance between the contact surface of the armature and the contact surface of the rotor is improved. As a result, within a short period of time from the time of starting the transmission and the block of the torque, the transmission torque is increased in comparison to the initial state of the friction surfaces, and a stable high transmission torque can be obtained.

Furthermore, the contact surface side region of the clutch of the present disclosure is a region, in which the nitride compound of the element of the base material is generated through the nitridization of the part of the base material, and the contact surface side region is a portion of the armature or the rotor. Therefore, in comparison to a case where a member, which corresponds to the contact surface side region, is joined to the contact surface unlike the clutch of the present disclosure, the number of components can be reduced.

According to another aspect of the present disclosure, there is provided a manufacturing method of a clutch that includes: a rotor that has a steel material as a base material of the rotor, wherein the rotor is rotated when the rotor receives a rotational drive force from a drive source; and an armature that has a steel material as a base material of the armature, wherein the rotational drive force is conducted to the armature when the armature is attracted to and is engaged with the rotor by a magnetic force, the manufacturing method including:

a processing step of forming the armature, which includes a contact surface that contacts a counterpart when the armature is attracted to and is engaged with the rotor, by applying a mechanical process to the base material of the armature;

a nitrocarburizing step of forming a contact surface side region, which is harder than the base material of the armature and includes a plurality of pores that open at the contact surface, by applying a nitrocarburizing process to at least the contact surface of the armature after the processing step; and

an anti-rust step of forming an anti-rust film by applying an anti-rust process to a region at a surface of the armature, which is other than at least the contact surface after the nitrocarburizing step.

The contact surface side region, which is formed by the nitrocarburizing process, has the nitride compound of the element of the base material generated therein, and the contact surface side region is a layer that is harder than an unreacted portion of the base material of the armature, which is unreacted at the nitridization. Therefore, the clutch of the present disclosure can be manufactured by this manufacturing method of the clutch.

Furthermore, in general, the heating temperature at the nitrocarburizing process is 550 to 600 degrees Celsius. An anti-rust coating film, which is formed by an ordinary anti-rust process, is lost or deteriorated under the heating temperature of this nitrocarburizing process. Therefore, when the nitrocarburizing step is executed after the anti-rust step, the anti-rust film is lost or deteriorated. Thereby, the high corrosion resistance of the clutch cannot be ensured.

In view of the above point, the nitrocarburizing step is executed before the anti-rust step, so that the loss or deterioration of the anti-rust film by the nitrocarburizing process can be avoided. Thereby, the high corrosion resistance of the clutch can be ensured.

According to a further aspect of the present disclosure, the processing step includes a finishing step of forming the contact surface of the armature by cutting a surface of the base material, which is press formed into a shape of the armature.

When the finishing step is executed after the nitrocarburizing step, the porous contact surface side region, which is formed at the nitrocarburizing step, is cut and is thereby lost. In view of the above point, the nitrocarburizing step is executed after the processing step, which includes the finishing step, so that the loss of the porous contact surface side region by the finishing step can be avoided.

Thus, according to this manufacturing method of the clutch, it is possible to manufacture the clutch, in which the porous contact surface side region is formed at the contact surface of the armature, and the anti-rust film is formed at the region of the armature, which is other than the contact surface.

According to a further aspect of the present disclosure, there is provided a manufacturing method of a clutch that includes: a rotor that has a steel material as a base material of the rotor, wherein the rotor is rotated when the rotor receives a rotational drive force from a drive source; and an armature that has a steel material as a base material of the armature, wherein the rotational drive force is conducted to the armature when the armature is attracted to and is engaged with the rotor by a magnetic force, the manufacturing method including:

a processing step of forming the rotor, which includes a contact surface that contacts a counterpart when the armature is attracted to and is engaged with the rotor, by applying a mechanical process to the base material of the rotor;

a nitrocarburizing step of forming a contact surface side region, which is harder than the base material of the rotor and includes a plurality of pores that open at the contact surface, by applying a nitrocarburizing process to at least the contact surface of the rotor after the processing step; and

an anti-rust step of forming an anti-rust film by applying an anti-rust process to a region at a surface of the rotor, which is other than at least the contact surface after the nitrocarburizing step.

The contact surface side region, which is formed by the nitrocarburizing process, has the nitride compound of the element of the base material generated therein, and the contact surface side region is a layer that is harder than an unreacted portion of the base material of the rotor, which is unreacted at the nitridization. Therefore, the clutch of the present disclosure can be manufactured by this manufacturing method of the clutch.

Furthermore, in general, the heating temperature at the nitrocarburizing process is 550 to 600 degrees Celsius. An anti-rust coating film, which is formed by an ordinary anti-rust process, is lost or deteriorated under the heating temperature of this nitrocarburizing process. Therefore, when the nitrocarburizing step is executed after the anti-rust step, the anti-rust film is lost or deteriorated. Thereby, the high corrosion resistance of the clutch cannot be ensured.

In view of the above point, the nitrocarburizing step is executed before the anti-rust step, so that the loss or deterioration of the anti-rust film by the nitrocarburizing process can be avoided. Thereby, the high corrosion resistance of the clutch can be ensured.

According to another aspect of the present disclosure, the processing step includes a finishing step of forming the contact surface of the rotor by cutting a surface of the base material, which is press formed into a shape of the rotor.

When the finishing step is executed after the nitrocarburizing step, the porous contact surface side region, which is formed at the nitrocarburizing step, is cut and is thereby lost. In view of the above point, the nitrocarburizing step is executed after the processing step, which includes the finishing step, so that the loss of the porous contact surface side region by the finishing step can be avoided.

Thus, according to this manufacturing method of the clutch, it is possible to manufacture the clutch, in which the porous contact surface side region is formed at the contact surface of the rotor, and the anti-rust film is formed at the region of the rotor, which is other than the contact surface.

### BRIEF DESCRIPTION OF DRAWINGS

FIG. 1 is a cross-sectional view of an electromagnetic clutch according to a first embodiment.

FIG. 2 is an enlarged view of an area II of an armature in FIG. 1.

FIG. 3 is an enlarged view of a white layer and a compound layer shown in FIG. 2.

FIG. 4 is a diagram showing a manufacturing process of an armature according to the first embodiment.

FIG. 5 is an enlarged cross-sectional view of a friction surface of the armature at a time of using the clutch.

FIG. 6 is a diagram showing a result of evaluation of a transmission torque of the electromagnetic clutch of the present embodiment and a transmission torque of an electromagnetic clutch of a first comparative example.

FIG. 7 is a diagram showing a manufacturing process of an armature in the first comparative example.

FIG. 8 is an enlarged cross-sectional view of a rotor according to another embodiment.

FIG. 9 is an enlarged view of a white layer and a compound layer shown in FIG. 8.

FIG. 10 is a diagram showing a manufacturing process of a rotor according to the other embodiment.

FIG. 11 is an enlarged cross-sectional view of a friction surface of the rotor at a time of using the clutch.

### DESCRIPTION OF EMBODIMENTS

Various embodiments of the present disclosure will be described with reference to the accompanying drawings. In each of the following embodiments, the same or similar components are indicated by the same reference signs.

### First Embodiment

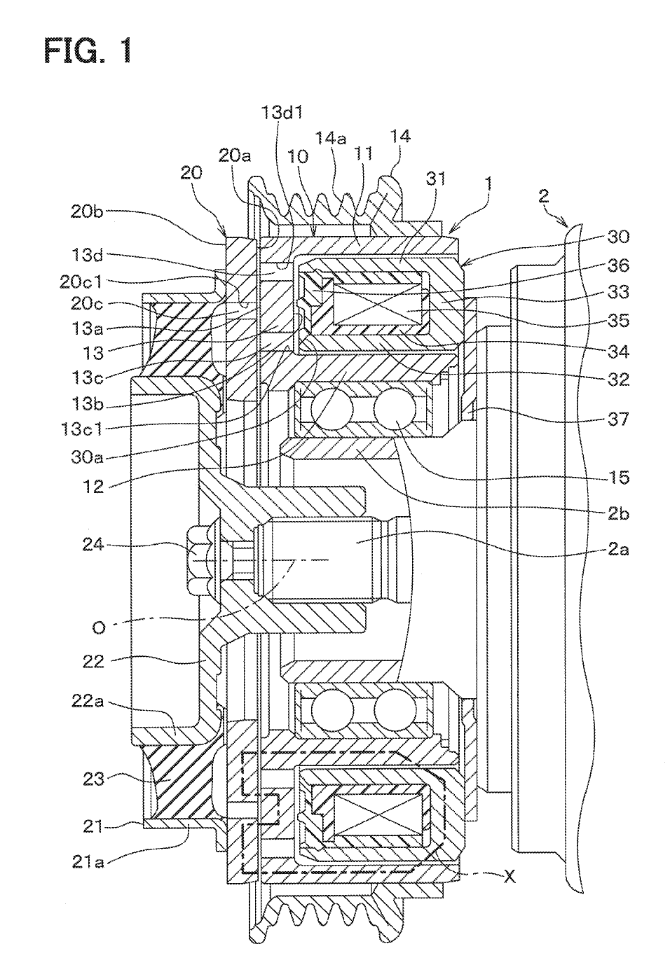

An electromagnetic clutch 1 of a first embodiment shown in FIG. 1 is used in a drive mechanism of a compressor 2. The drive mechanism of the compressor 2 rotates a compression mechanism when the drive mechanism receives a rotational drive force from an engine, which serves as a drive source that outputs a drive force for driving a vehicle. Therefore, in the present embodiment, the engine is the drive source, and the compressor 2 is a driven-side apparatus.

The compressor 2 suctions and compresses refrigerant. The compressor 2 cooperates with a radiator, an expansion valve and an evaporator to form a refrigeration cycle apparatus of a vehicle air conditioning system. The radiator radiates heat from the refrigerant, which is discharged from the compressor 2. The expansion valve depressurizes and expands the refrigerant, which is outputted from the radiator. The evaporator evaporates the refrigerant, which is depressurized by the expansion valve, to implement heat absorption.

The electromagnetic clutch 1 includes a rotor 10 and an armature 20. The rotor 10 forms a driving-side rotatable body, which is rotated about a rotational central axis O thereof when the rotor 10 receives the rotational drive force from the engine. The armature 20 forms a driven-side rotatable body, which is connected to a rotatable shaft 2a of the compressor 2. When the rotor 10 and the armature 20 are coupled with each other, conduction of the rotational drive force (i.e., a torque) from the engine to the compressor 2 is enabled. In contrast, when the rotor 10 and the armature 20 are decoupled from each other, the conduction of the rotational drive force from the engine to the compressor 2 is disabled. FIG. 1 shows a state where the rotor 10 and the armature 20 are decoupled from each other.

That is, when the electromagnetic clutch 1 couples between the rotor 10 and the armature 20, the rotational drive force of the engine is conducted to the compressor 2 to drive the refrigeration cycle apparatus. In contrast, when the electromagnetic clutch 1 decouples between the rotor 10 and the armature 20, the rotational drive force of the engine is not conducted to the compressor 2. Thereby, the refrigeration cycle apparatus is not driven. The operation of the electromagnetic clutch 1 is controlled by a control signal, which is outputted from an air conditioning control device that controls the operation of each of the constituent devices of the refrigeration cycle apparatus.

Now, a specific structure of the electromagnetic clutch 1 will be described. As shown in FIG. 1, the electromagnetic clutch 1 includes the rotor 10, the armature 20 and a stator 30.

The rotor 10 has a double cylindrical tubular structure, which has an opening on an axial side that is spaced away from and is opposite from the armature 20, and a cross section of the double cylindrical tubular body of the rotor 10 is configured to have a U-shape. Specifically, the rotor 10 includes an outer cylindrical tubular portion 11, an inner cylindrical tubular portion 12 and an end surface portion 13. The inner cylindrical tubular portion 12 is placed on a radially inner side of the outer cylindrical tubular portion 11. The end surface portion 13 extends in a direction that is perpendicular to the rotational central axis O in such a manner that the end surface portion 13 connects between an end part of the outer cylindrical tubular portion 11 and an end part of the inner cylindrical tubular portion 12, which are located on an axial side where the armature 20 is located. The outer cylindrical tubular portion 11, the inner cylindrical tubular portion 12 and the end surface portion 13 are made of low-carbon steel (e.g., S12C), which has carbon content of 0.3% or smaller.

The outer cylindrical tubular portion 11 and the inner cylindrical tubular portion 12 are arranged coaxially with the rotatable shaft 2a of the compressor 2. Specifically, the rotational central axis O of FIG. 1 serves as a rotational central axis of the outer cylindrical tubular portion 11, a rotational central axis of the inner cylindrical tubular portion 12 and a rotational central axis of the rotatable shaft 2a. A pulley 14 is connected to an outer peripheral part of the outer cylindrical tubular portion 11. V-shaped grooves 14a, around which a V-belt is wound, are formed at the pulley 14. An outer race of a ball bearing 15 is fixed to an inner peripheral part of the inner cylindrical tubular portion 12.

The ball bearing 15 rotatably supports the rotor 10 relative to a housing that forms an outer shell of the compressor 2. Therefore, an inner race of the ball bearing 15 is fixed to a housing boss 2b, which is formed at the housing of the compressor 2.

The end surface portion 13 is a wall portion that is opposed to the armature 20. The end surface portion 13 includes one surface 13a, which is located on the armature 20 side, and the other surface 13b, which is located on the side that is opposite from the armature 20 side. In other words, the end surface portion 13 includes the one surface 13a and the other surface 13b, which are located on the one side and the other side in the axial direction of the rotational central axis O. Furthermore, the one surface 13a and the other surface 13b extend in the direction that is perpendicular to the axial direction. The one surface 13a of the end surface portion 13 is opposed to the armature 20. The one surface 13a of the end surface portion 13 serves as a contact surface 13a that contacts the armature 20, which is a counterpart, when the armature 20 is coupled with the rotor 10. The contact surface 13a also serves as a friction surface that generates friction through contact with the armature 20. Hereinafter, the one surface 13a of the end surface portion 13 will be referred to as a friction surface 13a.

A plurality of magnetically insulating slits 13c, 13d, which interrupt a flow of a magnetic flux, is formed at the friction surface 13a of the end surface portion 13. In the present embodiment, the magnetically insulating slits 13c, 13d, each of which is configured into an arcuate form, are arranged one after another in a radial direction. The magnetically insulating slits 13c, 13d are formed by magnetically insulating slit forming parts 13c1, 13d1. The magnetically insulating slits 13c, 13d extend in the axial direction through the end surface portion 13 from the friction surface 13a to the other surface 13b, which is opposite from the friction surface 13a.

Similar to the rotor 10, the armature 20 is made of the low-carbon steel, such as S12C. The armature 20 is a circular disk member, which extends in a direction perpendicular to the rotational central axis O and has a through-hole that extends in the axial direction of the rotational central axis O through a center part of the circular disk member. A rotational center of the armature 20 is coaxial with the rotatable shaft 2a of the compressor 2. Specifically, the rotational central axis of the armature 20 coincides with the rotational central axis O.

The armature 20 includes one surface 20a, which is located on the rotor 10 side, and the other surface 20b, which is located on an opposite side that is opposite from the rotor 10. In other words, the armature 20 includes the one surface 20a and the other surface 20b, which are respectively located on the one side and the other side in the axial direction of the rotational central axis O. Furthermore, the one surface 20a and the other surface 20b extend in the direction that is perpendicular to the axial direction. The one surface 20a of the armature 20 is opposed to the rotor 10. The one surface 20a of the armature 20 serves as a contact surface 20a that contacts the rotor 10, which is a counterpart, when the armature 20 is coupled with the rotor 10. The contact surface 20a also serves as a friction surface that generates friction through contact with the rotor 10. Hereinafter, the one surface 20a of the armature 20 will be referred to as a friction surface 20a.

Similar to the end surface portion 13 of the rotor 10, magnetically insulating slits 20c are formed at the friction surface 20a of the armature 20. In the present embodiment, the magnetically insulating slits 20c are formed as a plurality of magnetically insulating slits 20c, each of which is shaped into an arcuate form. The magnetically insulating slits 20c are formed by magnetically insulating slit forming parts 20c1. The magnetically insulating slits 20c extend through the armature 20 in the axial direction from the friction surface 20a to the other surface 20b that is opposite from the friction surface 20a. The magnetically insulating slits 20c are radially placed between the magnetically insulating slit 13c, which is located on the radially inner side at the end surface portion 13, and the magnetically insulating slit 13d, which is located on the radially outer side at the end surface portion 13.

An outer hub 21, which is shaped into a circular disk form, is fixed to the other surface 20b of the armature 20. The outer hub 21 and an inner hub 22 described later form a connecting member, which connects between the armature 20 and the rotatable shaft 2a of the compressor 2. Each of the outer hub 21 and the inner hub 22 includes a cylindrical tubular portion 21a, 22a, which extends in the axial direction of the rotational central axis O. A cylindrical tubular rubber 23 is vulcanized and is secured to an inner peripheral surface of the cylindrical tubular portion 21a of the outer hub 21 and an outer peripheral surface of the cylindrical tubular portion 22a of the inner hub 22. The rubber 23 is a resilient member that is made of a resilient material (i.e., an elastomer).

Furthermore, the inner hub 22 is fixed by tightly screwing a bolt 24 into a threaded screw hole that is formed at the rotatable shaft 2a of the compressor 2. That is, the inner hub 22 is configured to be coupleable relative the rotatable shaft 2a of the compressor 2.

In this way, the armature 20, the outer hub 21, the rubber 23, the inner hub 22 and the rotatable shaft 2a of the compressor 2 are joined one after another. When the rotor 10 and the armature 20 are coupled with each other, the armature 20, the outer hub 21, the rubber 23, the inner hub 22 and the rotatable shaft 2a of the compressor 2 are rotated together with the rotor 10.

Furthermore, the rubber 23 exerts a resilient force relative to the outer hub 21 in a direction away from the rotor 10. In the decoupled state where the rotor 10 and the armature 20 are decoupled from each other by this resilient force, a predetermined gap is formed between the friction surface 13a of the rotor 10 and the friction surface 20a of the armature 20 that is joined to the outer hub 21.

The stator 30 is placed in an inside space of the rotor 10, which is defined by the outer cylindrical tubular portion 11, the inner cylindrical tubular portion 12 and the end surface portion 13 of the rotor 10. Thereby, the stator 30 is opposed to the other surface 13b of the end surface portion 13. The stator 30 is made of a magnetic material (e.g., an iron material) and receives an electromagnetic coil 35 in an inside of the stator 30.

The stator 30 has a double cylindrical tubular structure, which has an opening 30a on an axial side where the end surface portion 13 is located, and a cross section of the stator 30 is shaped into a U-shape. Specifically, the stator 30 includes an outer cylindrical tubular portion 31, an inner cylindrical tubular portion 32 and an end surface portion 33. The inner cylindrical tubular portion 32 is placed on a radially inner side of the outer cylindrical tubular portion 31. The end surface portion 33 extends in the direction that is perpendicular to the rotational central axis O in such a manner that the end surface portion 33 connects between an end part of the outer cylindrical tubular portion 31 and an end part of the inner cylindrical tubular portion 32, which are located on the axial side that is axially spaced away from the friction surface 13a of the rotor 10.

A coil spool 34, which is shaped into an annular form, is received in the inside space of the stator 30. The coil spool 34 is made of a resin material (e.g., polyamide resin). The electromagnetic coil 35 is wound around the coil spool 34.

Furthermore, a resin member 36, which seals the electromagnetic coil 35 and is made of a resin material (e.g., polyamide resin), is provided at the opening 30a of the stator 30. In this way, the opening 30a of the stator 30 is closed by the resin member 36.

Furthermore, a stator plate 37 is fixed to the outer side (the right side in FIG. 1) of the end surface portion 33 of the stator 30. The stator 30 is fixed to the housing of the compressor 2 through the stator plate 37.

Next, the operation of the electromagnetic clutch 1 having the above-described structure will be described. When the electromagnetic coil 35 is energized, the magnetic flux flows in the magnetic circuit X, in which the magnetic flux flows in the stator 30, the rotor 10 and the armature 20 and returns to the stator 30, as indicated by a dot dash line in FIG. 1. In this way, the magnetic force is generated between the rotor 10 and the armature 20. Therefore, when the electromagnetic coil 35 is energized, the armature 20 is attracted to and is engaged with the friction surface 13a of the rotor 10 by the magnetic force generated from the electromagnetic coil 35. In this way, the rotor 10 and the armature 20 are coupled with each other. Thereby, the rotational drive force is conducted from the engine to the compressor 2.

When the electromagnetic coil 35 is deenergized, i.e., when the electromagnetic coil 35 is held in the deenergized state, the magnetic force is not generated. Thereby, the armature 20 is decoupled from the friction surface 13a of the rotor 10 by the resilient force of the rubber 23. Thereby, the rotational drive force is not conducted from the engine to the compressor 2.

Next, an internal structure of the armature 20 will be described.

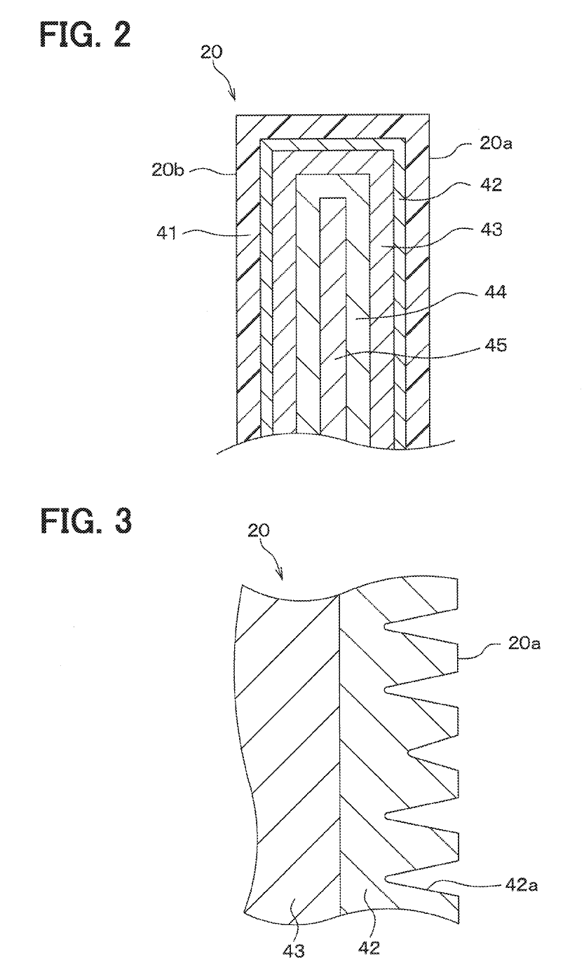

The armature 20 has low-carbon steel as a base material of the armature 20, and this base material is processed through a nitrocarburizing process and a coating process, which are applied in this order. Therefore, as shown in FIG. 2, the armature 20 includes a coating film 41, a white layer 42, a compound layer 43 and a diffusion layer 44, which are arranged in this order from an outer side of the armature 20. It should be noted that FIG. 2 shows a cross section of the armature 20, in which a friction surface 20a is in its initial state. Therefore, in FIG. 2, the coating film 41 is present at the friction surface 20a.

The coating film 41 is an anti-rust film that is provided for the anti-rust purpose. The coating film 41 is made of a paint that includes synthetic resin (e.g., epoxy resin) as a main component of the paint.

Both of the white layer 42 and the compound layer 43 are layers, in which a nitride compound of an element of the base material is generated through nitridization of a part of the base material. In other words, the white layer 42 and the compound layer 43 are layers that have a composition including iron, nitrogen and carbon, and ε-Fe₂₋₃N and Fe₃C are formed in these layers. The white layer 42 and the compound layer 43 are layers that are harder than the diffusion layer 44 and the base material 45, which serve as a foundation of the white layer 42. That is, the white layer 42 and the compound layer 43 are layers, each of which has relatively high hardness. The diffusion layer 44 is a layer where the nitrogen is diffused into the base material. The base material 45 is located on the inner side of the diffusion layer 44. A thickness of the white layer 42 is few micrometers (e.g., equal to or larger than 2 μm and is equal to or smaller than 10 μm). A thickness of the compound layer 43 is about 10 μm (e.g., equal to or larger than 8 μm and is equal to or smaller than 15 μm). A thickness of the diffusion layer 44 is equal to or larger than 0.3 mm and is equal to or smaller than 0.5 mm.

As shown in FIG. 3, the white layer 42 is a porous layer that has a large number of pores 42a at a surface of the layer. The compound layer 43 is a dense layer that is not porous. Therefore, in the present embodiment, the white layer 42 is a contact surface side region, which includes the friction surface 20a of the armature 20 and has the pores 42a opened at the friction surface 20a, while the contact surface side region is harder than an unreacted portion of the base material that is not reacted at the nitridization. Furthermore, the pores 42a are pores that can receive and hold powder 42b generated through abrasion of the contact surface side region caused by coupling and decoupling between the rotor 10 and the armature 20, as described later, FIG. 3 is a cross sectional view showing an area around the friction surface 20a of the armature 20 in a state where the coating film 41 is lost from the friction surface 20a.

In the present embodiment, the white layer 42 is the layer that has the composition including iron, nitrogen and carbon. More specifically, the white layer 42 is the layer, in which Fe₂₋₃N and Fe₃C are formed. However, the white layer 42 may have another composition as long as the layer is harder than the base material 45 and is porous. For example, the white layer 42 may have a composition that includes iron and nitrogen and does not include carbon. Furthermore, a nitride of another element(s), which is other than Fe and is included in the base material, may be formed in the white layer 42.

Furthermore, in the present embodiment, as shown in FIG. 2, the white layer 42 is formed along the entire extent of the surface of the armature 20. However, it is only required that the white layer 42 is formed at least at the friction surface 20a in the entire surface of the armature 20. Furthermore, although it is preferred that the white layer 42 is formed along the entire extent of the friction surface 20a, the white layer 42 may be formed only at a fraction of the friction surface 20a.

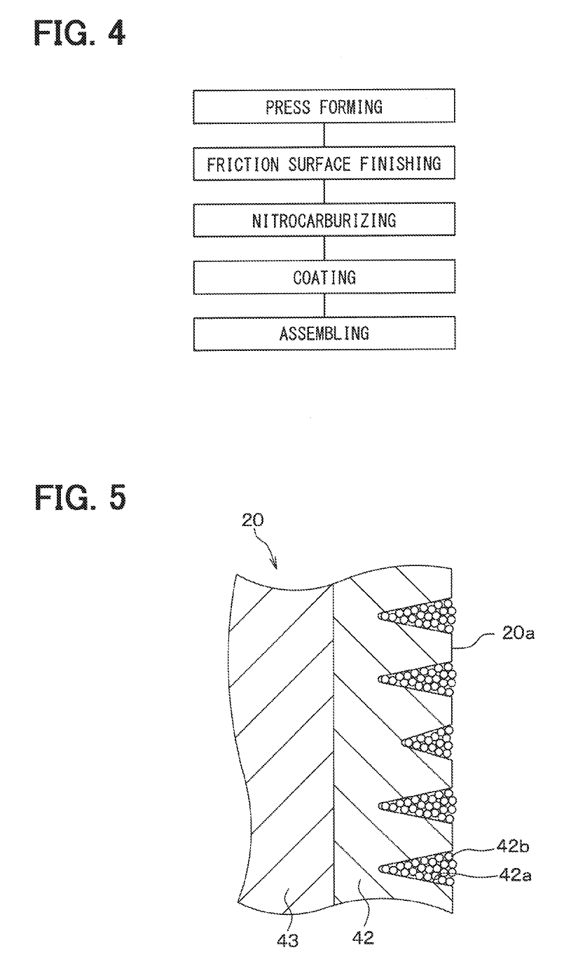

Next, a manufacturing method of the electromagnetic clutch 1 of the present embodiment will be described. The electromagnetic clutch 1 is manufactured by assembling the constituent components, such as, the rotor 10 and the armature 20 of the electromagnetic clutch 1. In the present embodiment, as shown in FIG. 4, the armature 20 is manufactured through a press forming step, a friction surface finishing step, a nitrocarburizing step and a coating step, and thereafter an assembling step is executed.

At the press forming step, the base material is shaped into the shape of the armature 20 through the press forming of the base material. At the friction surface finishing step, a surface side portion of the base material, which is press formed into the shape of the armature 20, is smoothed by, for example, cutting and polishing, so that the friction surface 20a of the armature 20 is formed. As discussed above, the armature 20, which has the friction surface 20a, is formed through the mechanical processing steps, which include the press forming step and the friction surface finishing step.

At the nitrocarburizing step, the nitrocarburizing process is applied to the friction surface 20a of the armature 20 after the friction surface finishing step. In the present embodiment, salt bath nitrocarburizing is performed as the nitrocarburizing process. An ordinary processing method may be used as the salt bath nitrocarburizing process. The heating temperature of the nitrocarburizing process is about 550 to 600 degrees Celsius.

In this way, at a surface layer of the friction surface 20a of the armature 20, the white layer 42 and the compound layer 43, which have the structure shown in FIG. 3, are formed. At this time, nitrogen is diffused into the base material located at the inside of the armature 20, so that the base material at the inside of the armature 20 is referred to as the diffusion layer. In the present embodiment, as discussed above, the white layer 42 and the compound layer 43 are formed along the entire extent of the surface of the armature 20.

At the coating step, as an anti-rust process, a coating process is applied to a corresponding region of the surface of the armature 20, which is other than at least the friction surface 20a. In this way, at the corresponding region of the surface of the armature 20, which is other than the friction surface 20a, the coating film 41 is formed at the outermost layer of the armature 20. In the present embodiment, as discussed above, the coating film 41 is formed at the entire extent of the surface of the armature 20 in a manner shown in FIG. 2.

At the assembling step, the armature 20 and the hubs 21, 22 are assembled together after the coating process. Furthermore, the armature 20, the rotor 10 and the other components are assembled to the compressor 2.

Thereafter, a run-in operation (not shown) is conducted. At the run-in operation, energization and de-energization of the electromagnetic coil 35, i.e., turning on and off of the electromagnetic clutch 1 are repeated. In other words, coupling and decoupling between the armature 20 and the rotor 10 are repeated. In this way, the coating film 41 is removed from the friction surface 20a of the armature 20. Furthermore, the friction surface 20a of the armature 20 and the friction surface 13a of the rotor 10 are oxidized, so that the transmission torque is increased. Thereby, the electromagnetic clutch 1, which has the structure shown in FIG. 1, is manufactured.

In the present embodiment, the run-in operation is executed after the assembling of the armature 20, the rotor 10 and the other components to the compressor 2. Alternatively, the run-in operation may be performed while the armature 20, the rotor 10 and the other components are assembled to another rotatable body, which is other than the compressor 2. In this case, the armature 20, the rotor 10 and the other components are assembled to the compressor 2 after the run-in operation.

Next, advantages of the present embodiment will be described.

(1) In the present embodiment, the white layer 42, which is porous, is formed at the surface layer of the friction surface 20a (i.e., the surface side portion) of the armature 20.

Therefore, when the run-in operation starts, the white layer 42 of the friction surface 20a of the armature 20 is worn to generate the hard abrasion powder by repeating the coupling and decoupling between the armature 20 and the rotor 10. Then, as shown in FIG. 5, the thus generated hard abrasion powder 42b is trapped (held) in the pores 42a of the white layer 42.

In this way, the real contact area between the armature 20 and the rotor 10 at the time of coupling is improved. Also, due to the presence of the hard abrasion powder 42b between the friction surface 20a of the armature 20 and the friction surface 13a of the rotor 10, a friction resistance between the friction surface 20a of the armature 20 and the friction surface 13a of the rotor 10 is improved. As a result, within a short period of time from the time of starting the run-in operation, the transmission torque is increased in comparison to the initial state of the friction surfaces 20a, 10a, and a stable high transmission torque can be obtained. Thus, according to the present embodiment, a required time period, which is required for the run-in operation, can be shortened, and thereby a required time period, which is required for the manufacturing of the clutch, can be shortened.

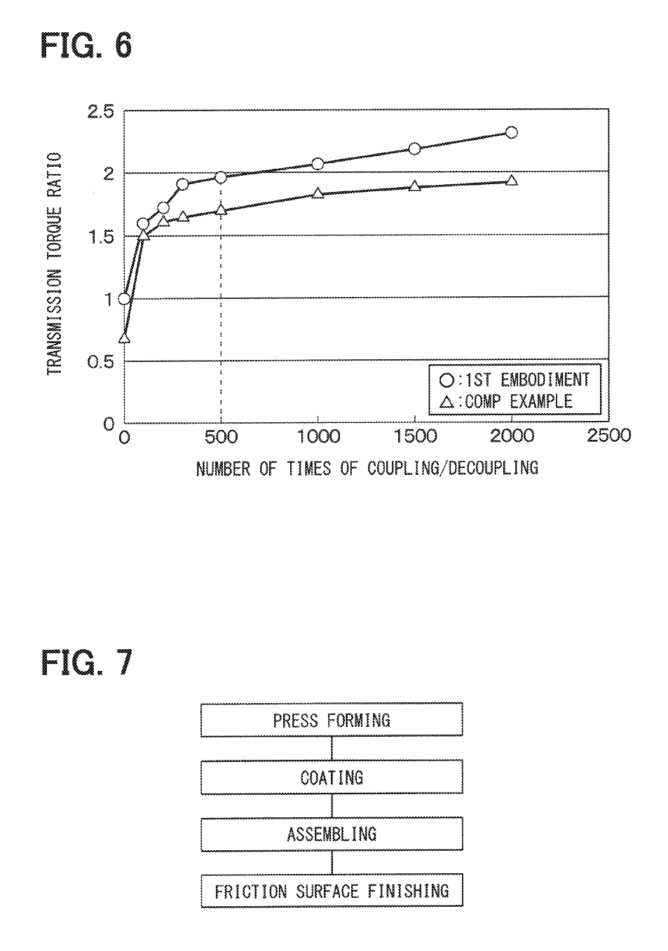

Here, FIG. 6 shows a result of evaluation of a transmission torque of the electromagnetic clutch 1 of the present embodiment and a transmission torque of an electromagnetic clutch of a first comparative example. FIG. 6 indicate measurement results of the transmission torque at the time of repeating the coupling and decoupling (i.e., contacting and non-contacting) between the rotor 10 and the armature 20. The electromagnetic clutch of the first comparative example differs from the electromagnetic clutch of the present embodiment with respect to that the nitrocarburizing process is not applied to the armature 20, and the rest of the structure of the electromagnetic clutch of the first comparative example is the same as that of the electromagnetic clutch of the present embodiment. Furthermore, the electromagnetic clutch of the first comparative example is formed by manufacturing and assembling the armature 20 through a procedure shown in FIG. 7, which will be described later, and the electromagnetic clutch of the first comparative example corresponds to a previously proposed electromagnetic clutch.

In FIG. 6, a vertical axis indicates a transmission torque ratio, and a horizontal axis indicates the number of times of coupling/decoupling (i.e., the number of contacts). The transmission torque ratio is a ratio of the transmission torque in a case where a value of the transmission torque is set to 1 for a state where the number of times of coupling/decoupling of the electromagnetic clutch of the first comparative example is zero. Furthermore, in this evaluation test, at the time of measuring the transmission torque, a contact load is set to be 3000 N. Also, at the time of coupling/decoupling, a rotational speed of the rotor is set to be 1000 rpm, and a contact load is set to be 4000 N.

In FIG. 6, with respect to the number of times of coupling/decoupling in a state where the transmission torque ratio is 2, in the case of the electromagnetic clutch of the first comparative example, even when the number of times of coupling/decoupling reaches 2000 times, the transmission torque ratio does not reach 2. In contrast, in the case of the electromagnetic clutch 1 of the present embodiment, when the number of times of coupling/decoupling is 500 times, the transmission torque ratio reaches 2. According to this result, it is understood that in the case of the electromagnetic clutch 1 of the present embodiment, within the short period of time from the time of starting the run-in operation, the transmission torque is increased in comparison to the initial state of the friction surfaces 20a, 10a, and the stable high transmission torque can be obtained.

Although the run-in operation is executed during the manufacturing process of the electromagnetic clutch 1 in the present embodiment, the run-in operation may not be executed during the manufacturing process of the electromagnetic clutch 1. In such a case, initial use of the electromagnetic clutch 1 in the market serves as the run-in operation. Even in such a case, within a short period of time from the time of starting the use of the electromagnetic clutch 1, the transmission torque is increased in comparison to the initial state of the friction surfaces 20a, 10a, and the stable high transmission torque can be obtained.

(2) The white layer 42 of the armature 20 is a layer that is formed through the nitrocarburizing process of the base material of the armature 20. Specifically, the white layer 42 is a layer, in which the nitride compound of the element of the base material of the armature 20 is generated through the nitridization of the part of the base material of the armature 20. Therefore, in comparison to a case where a member, which corresponds to the white layer 42, is joined to the friction surface 20a of the armature 20 unlike the present embodiment, the number of components can be reduced according to the present embodiment.

(3) In the present embodiment, the armature 20 is manufactured and is then assembled to the compressor 2 along with the other constituent components through the procedure shown in FIG. 4. In this way, both of the high torque transmission efficiency and the high corrosion resistance are achieved.

In general, as shown in FIG. 7, the previously proposed electromagnetic clutch is manufactured through the press forming step, the coating step, the assembling step, and the friction surface finishing step. At the assembling step of FIG. 7, the armature 20 and the hubs 21, 22 are assembled.

Therefore, in a case where the nitrocarburizing step described above is planned to be added to the manufacturing process of the previously proposed electromagnetic clutch shown in FIG. 7, it is conceivable to add the nitrocarburizing step after the friction surface finishing step. However, in such a case, the nitrocarburizing process is applied to the armature 20 that already has the coating film 41. Thus, the coating film 41 is lost by the heat in the nitrocarburizing process. Thus, the high corrosion resistance of the electromagnetic clutch 1 with the coating film 41 cannot be achieved.

In contrast, according to the present embodiment, the nitrocarburizing step is executed before the coating step. Therefore, the loss of the coating film through the nitrocarburizing process can be avoided, and thereby the high corrosion resistance of the electromagnetic clutch 1 can be ensured.

On the other hand, in the case where the nitrocarburizing step described above is planned to be added to the manufacturing process of the previously proposed electromagnetic clutch shown in FIG. 7, it is conceivable to add the nitrocarburizing step between the press forming step and the coating step in order to avoid the loss of the coating film 41. However, in such a case, the friction surface finishing step is executed after the nitrocarburizing process. Therefore, the white layer 42, which has the thickness of the few micrometers, is cut and removed at the friction surface finishing step. Thus, the high torque transmission efficiency, which is achieved with the white layer 42, cannot be obtained.

In contrast, according to the present embodiment, the nitrocarburizing step is executed after the friction surface finishing step. Therefore, it is possible to avoid the cutting and removal of the white layer 42. Thus, the high torque transmission efficiency, which is achieved with the white layer 42, can be obtained.

### Other Embodiments

The present disclosure should not be limited to the above embodiment, and the above embodiment may be appropriately modified within the scope of the claims.

(1) In order to limit wearing of the white layer 42, which is caused by the repeating of the coupling and decoupling between the armature 20 and the rotor 10, it is desirable that a friction material is provided to the friction surface 13a of the rotor 10. An ordinary friction material, which is used to improve the transmission torque, may be used as this friction material.

(2) In the first embodiment, the salt bath nitrocarburizing is used as the nitrocarburizing process. Alternatively, gas nitrocarburizing may be used. In such a case, a heating temperature and a gas concentration are set to correspond to a condition for forming the white layer 42. For example, the heating temperature may be set to be higher than the ordinary temperature, and the gas concentration may be set to be higher than the ordinary concentration. In this way, the white layer 42 can be formed even by the gas nitrocarburizing.

(3) In the first embodiment, the coating process is executed as the anti-rust process. Alternatively, another type of anti-rust process may be executed. The other type of anti-rust process may be, for example, a plating process, such as a zinc plating process, or a zinc-nickel plating process. However, the plating layer is also lost or deteriorated by the heating temperature of the nitrocarburizing process. Therefore, it is desirable that the plating process is executed after the nitrocarburizing process.

(4) In the first embodiment, the armature 20 is manufactured by executing the press forming step, the friction surface finishing step, the nitrocarburizing step, and the coating step in this order. Alternatively, another step(s) may be provided between any corresponding two of the above steps. Even in such a case, when the friction surface finishing step, the nitrocarburizing step and the coating step are executed in this order, the advantages, which are achieved in the first embodiment, can be achieved.

Furthermore, in the case where the friction surface is formed through the press forming, the friction surface finishing step may be eliminated. Even in such a case, when the nitrocarburizing step and the coating step are executed in this order after the press forming step, i.e., the processing step, which forms the armature having the friction surface through the mechanical processing, the advantages, which are similar to those of the first embodiment, can be achieved.

(5) In the first embodiment, the nitrocarburizing step is executed after the friction surface finishing step. However, if it is possible to avoid the cutting and removal of the white layer 42, the nitrocarburizing step may be executed before the friction surface finishing step.

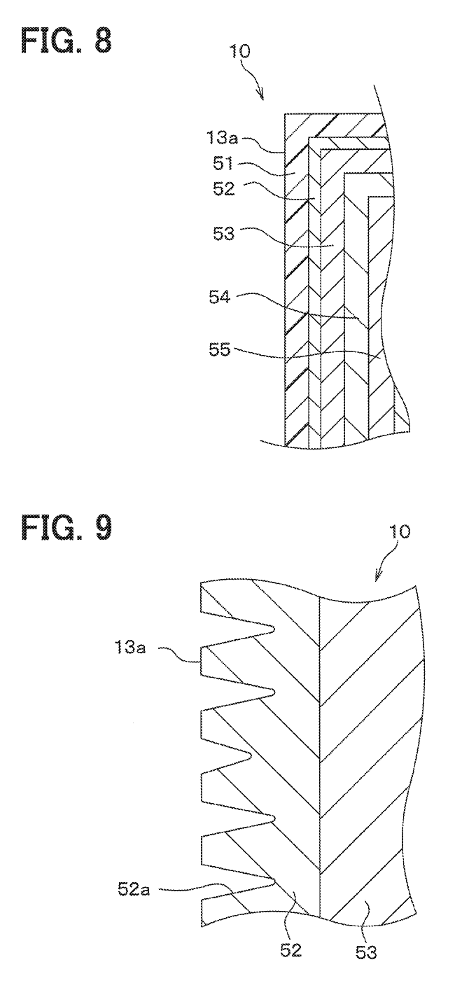

(6) In the first embodiment, the white layer 42 is formed at the surface layer of the friction surface 20a of the armature 20. Alternatively, a white layer 52, which has a large number of pores 52a, may be formed at an surface layer of the friction surface 13a of the rotor 10, as shown in FIGS. 8 and 9 instead of forming the white layer 42 at the friction surface 20a of the armature 20.

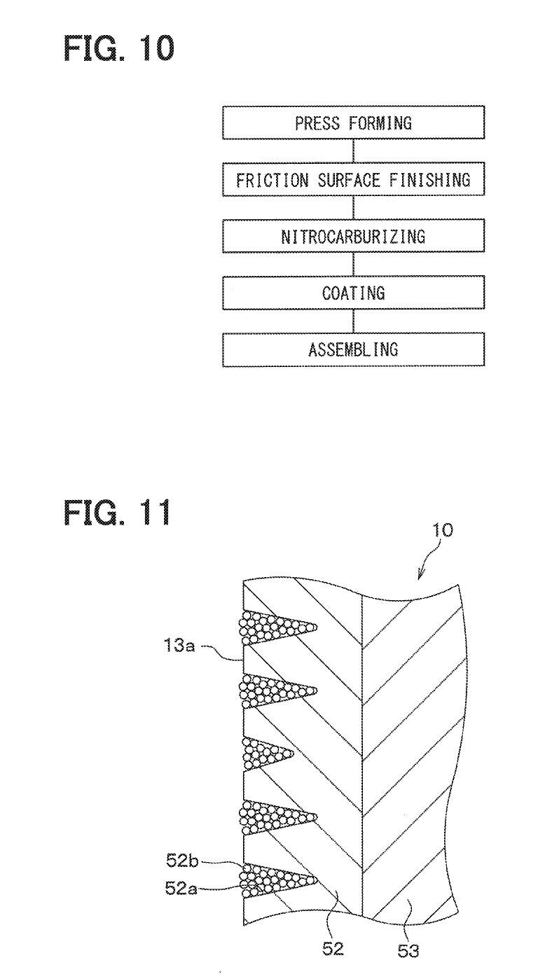

Similar to the armature shown in FIG. 2, the rotor 10 shown in FIG. 8 is formed by applying the nitrocarburizing process and the coating process in this order to a base material made of low-carbon steel, and thereby the rotor 10 includes a coating film 51, the white layer 52, a compound layer 53, a diffusion layer 54 and the base material 55, which are arranged in this order from the outer side. The coating film 51, the white layer 52, the compound layer 53, the diffusion layer 54 and the base material 55 respectively correspond to the coating film 41, the white layer 42, the compound layer 43, the diffusion layer 44 and the base material 45 shown in FIG. 2. Therefore, in this case, the white layer 52 is a contact surface side region, which includes the friction surface 13a of the rotor 10 and has the pores 52a opened at the friction surface 13a, while the contact surface side region is harder than an unreacted portion 55 of the base material that is not reacted through the nitridization. Furthermore, the pores 52a are pores that can hold therein powder 52b generated through abrasion of the contact surface side region caused by coupling and decoupling between the rotor 10 and the armature 20, as described later. It should be noted that FIG. 8 shows a cross section of the rotor 10, in which a friction surface 13a is in an initial state. Therefore, in FIG. 8, the coating film 51 is present at the friction surface 13a. Furthermore, the rotor 10 shown in FIG. 8 is manufactured by a manufacturing method, which is similar to the manufacturing method of the armature described in the first embodiment, as shown in FIG. 10.

As described above, the porous white layer 52 is formed at the surface layer of the friction surface 13a (the contact surface side region) of the rotor 10. Therefore, when the run-in operation starts, the white layer 52 is worn to generate the hard abrasion powder by repeating the coupling and decoupling between the armature 20 and the rotor 10. Then, as shown in FIG. 11, the thus generated hard abrasion powder 52b is trapped (i.e., held) in the pores 52a of the white layer 52. In this way, advantages, which are similar to those of the first embodiment, can be achieved.

Here, it should be noted that the white layer may be formed at both of the surface layer of the friction surface 20a of the armature 20 and the surface layer of the friction surface 13a of the rotor 10.

(7) In the first embodiment, the low-carbon steel is used as the base material of the rotor 10 and the base material of the armature 20. Alternatively, another type of steel material, which is a magnetic material, may be used as the base material of the rotor 10 and the base material of the armature 20. The type of steel material may be, for example, SPHC (hot-rolled steel sheet) or SPCC (cold rolled steel sheet).

(8) In each of the above embodiments, the clutch of the present disclosure is applied as the electromagnetic clutch, which magnetically attracts the armature 20 to the rotor 10 with the magnetic force generated from the electromagnetic coil. Alternatively, the clutch of the present disclosure may be applied as a clutch that uses a permanent magnet(s). In the clutch, which uses the permanent magnet(s), the coupling state between the rotor and the armature is maintained by a magnetic force of the permanent magnet(s), and a magnetic flux is generated at an electromagnetic coil such that the magnetic flux is applied to a magnetic circuit, which is formed by the permanent magnet(s), in the same direction as a flow direction of the magnetic flux generated by the permanent magnet(s) or an opposite direction, which is opposite from the flow direction of the magnetic flux. In this way, the coupling between the rotor and the armature and the decoupling between the rotor and the armature is switched.

(9) The above embodiments are not necessarily unrelated with each other, and the above embodiments may be combined in any appropriate combination unless such a combination is obviously impossible.

(10) In each of the above embodiments, some components of the embodiment are not necessarily indispensable unless the components are expressly indicated as indispensable components or are obviously considered as indispensable components in view of the principle of the present disclosure. Furthermore, in each of the above embodiments, in the case where the number of the component(s), the value, the amount, the range, or the like is specified, the present disclosure should not be limited to the number of the component(s), the value, the amount, or the like specified in the embodiment unless the number of the component(s), the value, the amount, or the like is indicated as indispensable or is obviously indispensable in view of the principle of the present disclosure. Furthermore, in each of the above embodiments, in the case where the material of the component(s), the shape of the component(s), and/or the positional relationship of the component(s) are specified, the present disclosure should not be limited to the material of the component(s), the shape of the component(s), and/or the positional relationship of the component(s) unless the embodiment specifically states that the material of the component(s), the shape of the component(s), and/or the positional relationship of the component(s) is necessary, or the embodiment states that the present disclosure is limited in principle to the material of the component(s), the shape of the component(s), and/or the positional relationship of the component(s) discussed above.

1. A clutch comprising:
a rotor that has a steel material as a base material of the rotor, wherein the rotor is rotated when the rotor receives a rotational drive force from a drive source; and
an armature that has a steel material as a base material of the armature, wherein the rotational drive force is conducted to the armature when the armature is attracted to and is engaged with the rotor by a magnetic force, wherein:
the armature includes a contact surface side region that includes a contact surface, which contacts a counterpart when the armature is attracted to and is engaged with the rotor;
the contact surface side region includes a plurality of pores that open at the contact surface, wherein a nitride compound of an element of the base material of the armature is formed at the contact surface side region through nitridization of a portion of the base material of the armature while the contact surface side region is harder than an unreacted portion of the base material of the armature, which is unreacted at the nitridization; and
the plurality of pores is capable of receiving and holding powder, which is generated by abrasion of the contact surface side region through engagement and disengagement between the rotor and the armature.

2. A clutch comprising:
a rotor that has a steel material as a base material of the rotor, wherein the rotor is rotated when the rotor receives a rotational drive force from a drive source; and
an armature that has a steel material as a base material of the armature, wherein the rotational drive force is conducted to the armature when the armature is attracted to and is engaged with the rotor by a magnetic force, wherein:
the armature includes a contact surface side region that includes a contact surface, which contacts a counterpart when the armature is attracted to and is engaged with the rotor;
the contact surface side region includes a plurality of pores that open at the contact surface, wherein a nitride compound of an element of the base material of the armature is formed at the contact surface side region while the contact surface side region is harder than the base material of the armature; and
the plurality of pores is capable of receiving and holding powder, which is generated by abrasion of the contact surface side region through engagement and disengagement between the rotor and the armature.

3. A clutch comprising:
a rotor that has a steel material as a base material of the rotor, wherein the rotor is rotated when the rotor receives a rotational drive force from a drive source; and
an armature that has a steel material as a base material of the armature, wherein the rotational drive force is conducted to the armature when the armature is attracted to and is engaged with the rotor by a magnetic force, wherein:
the rotor includes a contact surface side region that includes a contact surface, which contacts a counterpart when the armature is attracted to and is engaged with the rotor; and
the contact surface side region includes a plurality of pores that open at the contact surface, wherein a nitride compound of an element of the base material of the rotor is formed at the contact surface side region through nitridization of a portion of the base material of the rotor while the contact surface side region is harder than an unreacted portion of the base material of the rotor, which is unreacted at the nitridization; and
the plurality of pores is capable of receiving and holding powder, which is generated by abrasion of the contact surface side region through engagement and disengagement between the rotor and the armature.

4. A clutch comprising:
a rotor that has a steel material as a base material of the rotor, wherein the rotor is rotated when the rotor receives a rotational drive force from a drive source; and
an armature that has a steel material as a base material of the armature, wherein the rotational drive force is conducted to the armature when the armature is attracted to and is engaged with the rotor by a magnetic force, wherein:
the rotor includes a contact surface side region that includes a contact surface, which contacts a counterpart when the armature is attracted to and is engaged with the rotor; and
the contact surface side region includes a plurality of pores that open at the contact surface, wherein a nitride compound of an element of the base material of the rotor is formed at the contact surface side region while the contact surface side region is harder than the base material of the rotor; and
the plurality of pores is capable of receiving and holding powder, which is generated by abrasion of the contact surface side region through engagement and disengagement between the rotor and the armature.

5. The clutch according to claim 1, wherein the contact surface side region has a thickness that is equal to or larger than 2 μm and is equal to or smaller than 10 μm.

6. (canceled)

7. A manufacturing method of a clutch that includes:
a rotor that has a steel material as a base material of the rotor, wherein the rotor is rotated when the rotor receives a rotational drive force from a drive source; and
an armature that has a steel material as a base material of the armature, wherein the rotational drive force is conducted to the armature when the armature is attracted to and is engaged with the rotor by a magnetic force, the manufacturing method comprising:
a processing step of forming the armature, which includes a contact surface that contacts a counterpart when the armature is attracted to and is engaged with the rotor, by applying a mechanical process to the base material of the armature;
a nitrocarburizing step of forming a contact surface side region, which is harder than the base material of the armature and includes a plurality of pores that open at the contact surface, by applying a nitrocarburizing process to at least the contact surface of the armature after the processing step; and
an anti-rust step of forming an anti-rust film by applying an anti-rust process to a region at a surface of the armature, which is other than at least the contact surface after the nitrocarburizing step, wherein the plurality of pores is capable of receiving and holding powder, which is generated by abrasion of the contact surface side region through engagement and disengagement between the rotor and the armature.

8. The manufacturing method of the clutch according to claim 7, wherein the processing step includes a finishing step of forming the contact surface of the armature by cutting a surface of the base material, which is press formed into a shape of the armature.

9. A manufacturing method of a clutch that includes:
a rotor that has a steel material as a base material of the rotor, wherein the rotor is rotated when the rotor receives a rotational drive force from a drive source; and
an armature that has a steel material as a base material of the armature, wherein the rotational drive force is conducted to the armature when the armature is attracted to and is engaged with the rotor by a magnetic force, the manufacturing method comprising:
a processing step of forming the rotor, which includes a contact surface that contacts a counterpart when the armature is attracted to and is engaged with the rotor, by applying a mechanical process to the base material of the rotor;
a nitrocarburizing step of forming a contact surface side region, which is harder than the base material of the rotor and includes a plurality of pores that open at the contact surface, by applying a nitrocarburizing process to at least the contact surface of the rotor after the processing step; and
an anti-rust step of forming an anti-rust film by applying an anti-rust process to a region at a surface of the rotor, which is other than at least the contact surface after the nitrocarburizing step, wherein the plurality of pores is capable of receiving and holding powder, which is generated by abrasion of the contact surface side region through engagement and disengagement between the rotor and the armature.

10. The manufacturing method of the clutch according to claim 9, wherein the processing step includes a finishing step of forming the contact surface of the rotor by cutting a surface of the base material, which is press formed into a shape of the rotor.

11. (canceled)
